(19) United States
(12) Patent Application Publication
(10) Pub. No.: US 2026/0310573 A1
(43) Pub. Date: Oct. 8, 2026

(54) DEVICE DIGITAL TWIN

(71) Applicant: Mellanox Technologies, Ltd., Yokneam (IL)

(72) Inventors: Loai ABSAWY, Isfiya (IL); Eyal Davidovitz, Kfar Saba (IL); Roey Shilat, Haifa (IL)

(73) Assignee: Mellanox Technologies, Ltd., Yokneam (IL)

(21) Appl. No.: 19/172,878

(22) Filed: Apr. 8, 2025

(51) Int. Cl. G06F 11/34; G06F 9/455

(52) U.S. Cl. CPC G06F 11/3457; G06F 9/45558; G06F 2009/45591

(57) ABSTRACT

A system and method for uploading to a simulator of the computer system a state file generated by the computer system, the state file including data describing content of memory and hardware registers of the computer system, to generate a simulated computer system; and analyzing the simulated computer system using the simulator.

### BACKGROUND

Some embodiments relate to the field of modeling computer systems, and more particularly, to methods of modeling a computer system to enable debugging the computer system without access to the computer system.

In computing, bugs may refer to flaws, errors, or unintended behaviors in the functioning of a computer system that may cause the computer system to operate incorrectly or produce unexpected or incorrect results. These issues can arise from a variety of causes including coding mistakes, design flaws, misconfigurations (e.g., incorrect settings or parameters that lead to malfunction), errors that emerge from interactions with other systems, and other reasons. Debugging is the process of identifying and fixing these bugs to ensure the system operates as expected.

Debugging complex computing systems, that may include, for example, a host server operating one or more virtual machines (VMs) and connected to a network interface card (NIC), may be a complex task, and many debug tools have been developed to assist developers in the debugging of such systems. However, those debug tools typically need access to debugged system.

### SUMMARY

According to some embodiments, a computer-based system and method for modeling a computer system may include uploading to a simulator of the computer system a state file of the computer system, the state file comprising data describing content of memory and hardware registers of the computer system, to generate a simulated computer system; and analyzing the simulated computer system using the simulator.

According to some embodiments, the computer system may include a processor connected to a host computer executing a plurality of virtual machines (VMs), where the hardware registers may include configuration registers of the processor, and wherein the memory may include at least one of: device memory of the processor, cache memory of the processor, host memory, user memory which is accessible to the processor, and user memory allocated to the plurality of VMs which is accessible to the processor.

According to some embodiments, the computer system may include a network interface card (NIC) connected to a host computer and executing a plurality of virtual machines (VMs).

According to some embodiments, the hardware registers may include configuration registers on the NIC and the memory may include at least one of: device context memory of the NIC, cache memory of the NIC, host memory, user memory which is accessible to the NIC, and user memory allocated to the plurality of VMs which is accessible to the NIC.

According to some embodiments, the simulator may include a software application designed to mimic the behavior of the computer system.

According to some embodiments, generating the state file may include copying content of the memory and hardware registers to the state file in address and data tuples.

According to some embodiments, the simulator may include a software application designed to mimic behavior of the computer system, where the simulated computer system may include simulated memory and hardware registers, and uploading the state file to the simulator may include uploading, by the simulator, the data in each of the address and data tuples into the respective address in the simulated memory and hardware registers.

According to some embodiments, analyzing the computer system using the simulator may include executing analysis tools on the simulated memory and hardware registers.

According to some embodiments, executing the debug tools on the simulator may include displaying data in the simulated memory and hardware registers.

Embodiments may include using at least one of machine learning (ML) models or search tools to analyze the state file.

### BRIEF DESCRIPTION OF THE DRAWINGS

For a better understanding of embodiments of the disclosure and to show how the same can be carried into effect, reference will now be made, purely by way of example, to the accompanying drawings in which like numerals designate corresponding elements or sections throughout.

In the accompanying drawings:

FIG. 1 is a block diagram of an exemplary computing device which may be used with some embodiments;

FIG. 2 is a block diagram of a computing system capable of recording state files, according to some embodiments;

FIG. 3 is a block diagram of a simulator of computing system, according to some embodiments;

FIG. 4 is a flowchart of a method for modeling a computer system, according to some embodiments; and

FIG. 5 illustrates an example data center system, in accordance with at least one embodiment.

It will be appreciated that, for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

In the following detailed description, numerous specific details are set forth in order to provide a thorough understanding of the disclosure. However, it will be understood by those skilled in the art that the present disclosure can be practiced without these specific details. In other instances, well-known methods, procedures, and components, modules, units and/or circuits have not been described in detail so as not to obscure the disclosure.

Bugs may occur in computer systems that are already installed, for example at client premises. Developers of the computer system may be required to correct a bug without having access to the faulty computing systems. Many debugging tools have been developed in order to assist developers in the debugging process. Typically, debugging tools display or expose to the developer content of internal registers and memory locations, and changes in those internal registers and memory locations that happen during execution of the software. This may enable the developer to gain better understanding of the internal states of the computer system and may aid in detecting the cause for the bug. However, those debugging tools typically require access to the debugged computer system, which is not always feasible.

Embodiments may provide a system and method for modeling a computer system, and particularly for modeling the computer system to enable debugging of the computer system, without having access to the actual physical or real computer system. According to some embodiments, the modeled computer system may record contents of memory and hardware registers of the computer system. For example, the modeled computer system may generate a state file containing content of the memory and hardware registers of the computer system at a certain time point, in tuples of address and data or using other data structures.

The state file generated by the modeled computer system may be loaded or uploaded to a simulator of the computer system. The simulator may include a software code or application designed to model or mimic the behavior of the modeled computer system. The simulator may enable the developer to run software (SW) and/or firmware (FW) code suitable for or intended to be executed by the modeled computer system, without needing the actual physical computer system. The simulator may update the simulated memory and hardware registers according to the content provided in the state file, and may enable the developer to follow the internal states of the simulated computer system, e.g., the content of the memory and hardware registers at a given point in time. The simulator may be used to model the computer system and for executing various simulations on the modeled computer system. Additionally or alternatively, the simulated computer system may be used for debugging the modeled computer system. For example, the simulator may enable executing a variety of debug tools on the simulated computer system, e.g., the same or similar debug tools as the developer may use for debugging the physical computer system directly on the modeled computer system, e.g., the same or similar debug tools a developer would use when the developer does have access to the computer system. The debugging tools may include any tool that extracts information from the modeled or simulated computer system, and may be used by developers to observe the state of the modeled computer system and dissect it. The debug tools may parse and interpret the extracted data, and may present the raw extracted data, as well as the parsed or interpreted data.

In some embodiments, the modeled computer system may include a host device executing a plurality of VMs and connected to a processor having hardware registers, such as a processor of a NIC. In some embodiments, other computer systems may be modeled.

The modeled computer system may log or record content of various types of memory and hardware registers, including, for example, device context memory, cache memory, host memory, user memory which is accessible to the processor, user memory allocated to the plurality of VMs which is accessible to the processor, and any other types of memory as may be required.

In some embodiments, the memory of the modeled computer system may include complex structures that may be hard to interpret. Debug tools may, among other things, parse, interpret and analyze the memory content of the modeled computer system and present the content in a more structured manner. For example, memory allocated to a NIC may include queue pairs (QPs), send queues (SQs), receive queues (RQs), event queues (EQs) completion queues (CQs), etc. Some debug tools may parse content of the memory allocated to the NIC to present the relevant queues in a format that is more convenient to a developer.

Embodiments may improve the technology of computer system design, modeling and debugging, and may improve software and computers themselves, by enabling developers to model, simulate and debug computer systems without having access to those computer systems.

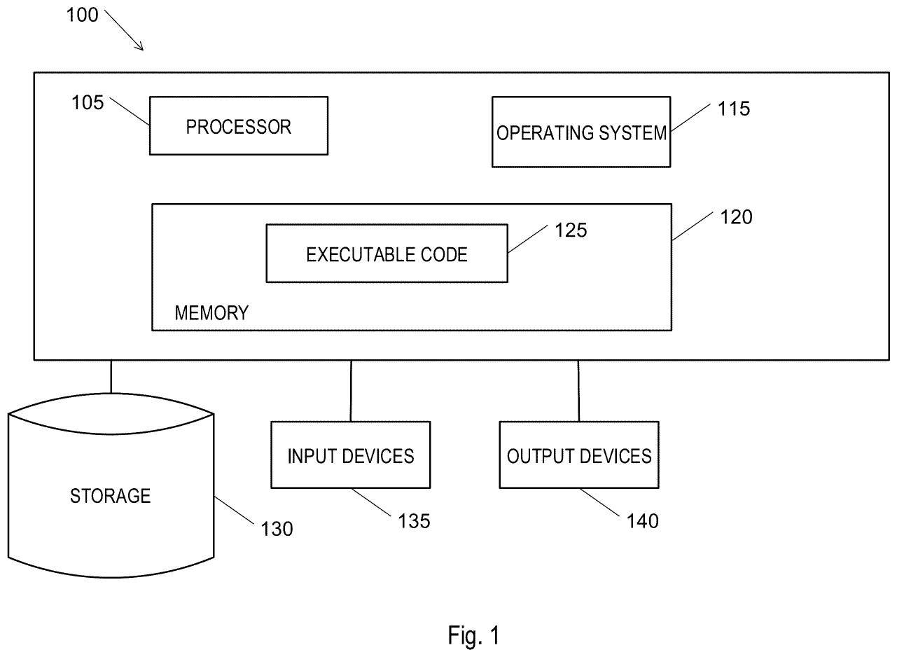

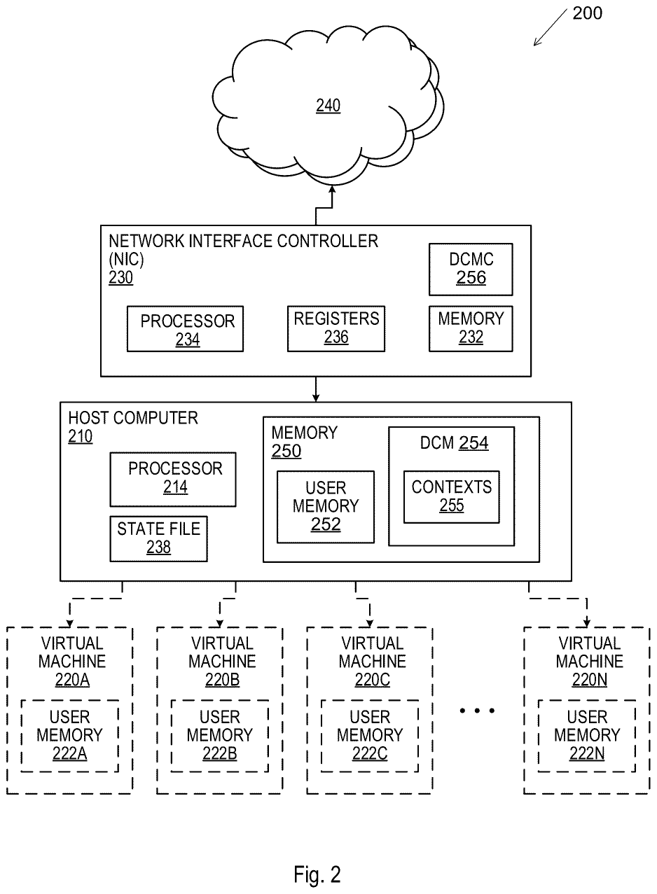

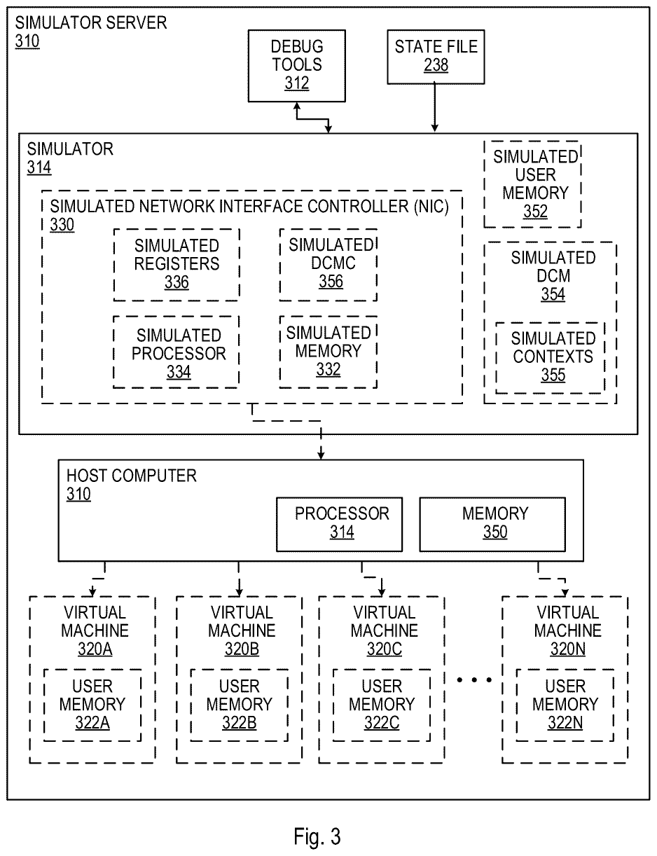

Reference is now made to FIG. 1, which is a block diagram of an exemplary computing device which may be used with some embodiments. Computing device 100 may include a controller or processor 105 that may be or include, for example, logic, one or more central processing unit processor(s) (CPU), one or more graphics processing unit(s) (GPU), one or more data processing unit(s) (DPU), one or more application-specific integrated circuits (ASICs), one or more field programmable arrays (FPGAs), one or more integrated circuits (ICs), a system-on-chip (SoC), a chip or any suitable computing or computational device, an operating system 115, a memory 120, a storage 130, input devices 135 and output devices 140. Each of the modules and equipment shown in FIGS. 2 and 3 such as host computer 210 and NIC 230 and simulator server 310, may be or include a computing device such as included in FIG. 1, although various units among these entities may be combined into one computing device.

Operating system 115 may be or may include any code segment designed and/or configured to perform tasks involving coordination, scheduling, arbitration, supervising, controlling or otherwise managing operation of computing device 100, for example, scheduling execution of programs. Memory 120 may be or may include, for example, a random access memory (RAM), a read only memory (ROM), a dynamic RAM (DRAM), a synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 120 may be or may include a plurality of possibly different memory units. Memory 120 may store for example, instructions to carry out a method (e.g., code 125), and/or data such as a state file, contexts, various queues as disclosed herein, etc.

Executable code 125 may be any executable code, e.g., software or firmware, an application, a program, a process, task or script. Executable code 125 may be executed by processor 105 possibly under control of operating system 115. In some embodiments, more than one computing device 100 or components of device 100 may be used for multiple functions described herein. For the various modules and functions described herein, one or more computing devices 100 or components of computing device 100 may be used. Devices that include components similar or different to those included in computing device 100 may be used, and may be connected to a network and used as a system. One or more processor(s) 105 may be configured to carry out embodiments by for example executing software or code. Storage 130 may be or may include, for example, a hard disk drive, a floppy disk drive, a compact Disk (CD) drive, a CD-recordable (CD-R) drive, a universal serial bus (USB) device or other suitable removable and/or fixed storage unit. Data, simulation data, may be stored in a storage 130 and may be loaded from storage 130 into a memory 120 where it may be processed by processor 105. In some embodiments, some of the components shown in FIG. 1 may be omitted.

Input devices 135 may be or may include a mouse, a keyboard, a touch screen or pad or any suitable input device. It will be recognized that any suitable number of input devices may be operatively connected to computing device 100 as shown by block 135. Output devices 140 may include one or more displays, speakers and/or any other suitable output devices. It will be recognized that any suitable number of output devices may be operatively connected to computing device 100 as shown by block 140. Any applicable input/output (I/O) devices may be connected to computing device 100, for example, a wired or wireless network interface card, a modem, printer or facsimile machine, a universal serial bus (USB) device or external hard drive may be included in input devices 135 and/or output devices 140.

Embodiments may include one or more article(s) (e.g., memory 120 or storage 130) such as a computer or processor non-transitory readable medium, or a computer or processor non-transitory storage medium, such as for example a memory, a disk drive, or a USB flash memory, encoding, including or storing instructions, e.g., computer-executable instructions, which, when executed by a processor or controller, carry out methods disclosed herein.

Reference is now made to FIG. 2, which is a block diagram of a modeled computer system 200 capable of generating a state file 238, according to some embodiments. State file 238 generated by modeled computer system 200, or by another computer system external to computer system 200 (not shown), may include content of memories 250 and/or 232, or parts of memories 250 and/or 232 as disclosed herein, and hardware registers 236. Elements and modules of FIG. 2 may be or may be executed by a computer system such as shown in the example of FIG. 1. It is noted that system 200 is an example only, and other computer systems may generate state files and be simulated according to embodiments.

System 200 may include a host computer or hypervisor 210. Host computer or hypervisor 210 may include a host memory 250 (e.g., such as memory 125 described above with respect to FIG. 1) and a processor 214 (e.g., such as processor 105 described above with respect to FIG. 1). Host computer or hypervisor 210 may execute a plurality of processes such as virtual machines (VMs) 220A, 220B, 220C . . . 220N (referred herein as “virtual machines 220A-220N”). Each virtual machine 220A-220N may be a virtualization or emulation of a computer system, which virtually executes other processes. Each of virtual machines 220A-220N may be based on a real physical computer architecture and provide functionality of that physical architecture to a process.

Portions or address spaces of host memory 250 may be allocated to various tasks. For example, a first portion of host memory 250 may be allocated to device context memory (DCM) 254, a second portion of host memory 250 may be allocated to user memory or host application memory, referred to as user memory 252, and a third portion of host memory 250 may be allocated to user memories 222A-222N of VMs 220A-220N, e.g., certain address spaces in host memory 250 may be allocated to DCM 254, other address spaces in host memory 250 may be allocated to user memory 252, and other address spaces in host memory 250 may be allocated to each of user memories 222A-222N. other allocations may be performed. Parts or all of user memory 252 and user memories 222A-222N may be accessible to NIC 230 or to processor 234 of NIC 230.

System 200 may include a NIC 230, also referred to as a network adapter. NIC 230 may provide access for virtual machines 220A-220N or other processes to a computer network 240 (e.g., the internet or the “cloud”). In some embodiments, NIC 230 may include a local memory 232 (e.g., such as memory 125 described above with respect to FIG. 1), a local cache, referred to herein as device context memory cache (DCMC) 256, and one or more processors 234 (e.g., such as processor 105 described above with respect to FIG. 1). In case NIC 230 includes local memory 232, some or all of DCM 254 may be implemented locally on memory 232. Memory 232 may further include memory arrays for storing data and other memory structures.

Each of DCM 254, user memory 252, and user memories 222A-222N may be implemented as virtual address (VA) space accessible by NIC processor 234. Each VA may have associated physical addresses (PA), pointing to a location in memories 250 and/or 232. The VAs may be mapped to PAs in memories 250 and/or 232 using any applicable translation method, e.g., using translation tables (TLBs), or any other translation method.

DCM 254 may include buffers to store contexts 255 of NIC 230, where a context may refer to a set of data that is related to a task. Contexts 255 may include, for example, hardware (HW) contexts, such as QPs, SQs, RQs, CQs, EQs, etc., and FW resources (not shown) such as data structures needed for FW to handle HW flows and resources. Other contexts or data items may be stored in DCM 254. As used herein, the FW may refer to software executable by NIC processor 234.

NIC processor 234 may receive a plurality of jobs or packets from virtual machines 220A-220N. NIC processor 234 may execute the plurality of jobs being received from virtual machines 220A-220N or other processes. The jobs may, for example, include opening or closing QPs, responsible for scheduling processor work, send or fetch work queue elements or any other jobs known in the art.

NIC 230 may include DCMC 256. When NIC processor 234 needs to access a certain virtual address in DCM 254, NIC processor 234 may first check if the virtual address exists in one of the ways of the appropriate set in DCMC 256. When NIC processor 234 performs a write operation, data may be cached in the appropriate set in a vacant way of DCMC 256, if all of the ways are taken NIC processor 234 (e.g., FW executed by NIC processor 234) may evict one of them. NIC processor 234 may lock a cache line in DCMC 256, meaning that the locked line will not be evicted while locked. Thus, locked data may be accessed by NIC processor 234 regardless of if there the VA of the locked line is backed by DCM 254 physical memory.

Registers 236 may include a small amount of fast storage accessible to NIC processor 234. Some of registers 236 may have specific hardware functions, while others may be general purpose fast storage.

In some applications, packet transmission processes may include preparing, typically by host processor 214, packet descriptors, or other packet defining structures, that include transmission scheduling instructions, such as “transmit at time X”, to be read and executed by NIC processor 234. The Mellanox Send operation is an example of one present technique employing such a strategy; as such, it makes use of a dedicated buffer in host memory 250, otherwise known as the SQ, where packet descriptors, which may be or may include work queue entries (WQEs), are stored. Descriptors may include packet-related information such as memory address, size, type of send operation to be performed, and the like, as well as transmission scheduling instructions (e.g. send at a specific time, do not send until packets include specific data, etc.). Once appropriate packet descriptors are stored in the SQ (e.g., in DCM 254), host processor 214 may update registers 236 of NIC 230 to read the SQ from DCM 254 and thereby trigger packet transmission based on packet descriptors' contents. In such a manner, packets may be transmitted at a desired time.

Once the SQs are allocated in DCM 254, host processor 210 may store the packet descriptors under consideration at any given time (e.g., such that the SQ is prepared for the next timeslot by including all packets and descriptors that are to be sent then). In a similar manner, host processor 214 may remove unused packets and descriptors from DCM 254 according to various performance requirements as known in the art. In some embodiments, host processor 214 may manage the SQ or other contexts by including in a payload of the description, one or more pointers, pointing to the one or more offsets in memory 250 and/or 232 where the packet data is stored.

Once descriptors are stored in SQ, processor 214 may associate one or more packets with a packet descriptor in advance of triggering or initiating packet sending or transmission by NIC 230 at a desired time. In some embodiments, this may be done by pointing the given descriptor's payload address to the right offset of memory 250 and/or 232 as known in the art. Different association methods and operations may be used as well. NIC 230 may, in response to the trigger, send or transmit the packets based on the associated packet descriptors and the information contained in them. In some embodiments, NIC 230 may be configured to read packet descriptors that have been received from a processing unit (e.g., sent to NIC 230 by processor 214), and schedule or determine packet transmission time based on their contents. In other embodiments, processor 214 may be configured to read packet descriptors and send relevant packets and/or descriptors to NIC 230 based on their contents. After sending the descriptors, or other entries related to the sent packet may be moved form the SQ to the CQ.

In some embodiments, initiating a processing procedure of incoming data packets, e.g., by host processor 214, may require for example first reading the received packets, e.g., by NIC 230. By performing for example a read operation by NIC 230 on incoming packets, e.g., right after they are received and stored in e.g. memory 232 or 250, signaling and/or notifying host processor 214 that these packets require or do not require further processing actions and/or protocols or procedures may be required. It should be noted that alternative operations, such as modifying the contents of incoming packets by another component within for example system 200, or performing read operations by such components instead of by NIC 230 may be used and/or included in other embodiments.

EQs may be used for handling interrupts in computing system 200. NIC 230 may be configured to write event indications to EQs of host processor 214 in combination with asserting one of the interrupts of host processor 214. Host processor 214 may then read and process the event from the EQ.

Thus, as NIC 230 performs its function of sending and receiving packets, the content of memories 250 and/or 232 may dynamically change as various queues or buffers may be allocated and entries may move into and out of the various queues or buffers in DCM 254. Memory locations, e.g., VAs and corresponding PAs may be dynamically allocated and released as needed to support current requirement for queues and buffers in accordance to the current tasks of NIC 230. Also, the physical location of VAs may change as data may move into and out of DCMC 256. Thus, following and knowing the content of memories 250 and/or 232 as well as of registers 236, or obtaining a snapshot of the content of memories 250 and/or 232 and registers 236, may be crucial for performing various tasks such as modeling and/or debugging of computer system 200. Knowing the content of memories 250 and/or 232 as well as of registers 236, and specifically of the content of the various queues in DCM 254, may enable a developer to perform knowledgeable debugging and modeling of computer system 200.

According to some embodiments, NIC processor 234 may generate state file 238 which includes data describing content of memories 250 and/or 232 that are accessible to NIC processor 234, and hardware registers 236 of computer system 200. In some embodiments, state file 238 may be generated by another processor (not shown), external to computer system 200 but connected to computer system 200. In some embodiments, NIC processor 234 may initiate generating state file 238. In some embodiments, host processor 214 may initiate generating state file 238, e.g., by sending a request to NIC processor 234 to generate state file 238. In some embodiments, another processor (not shown), external to computer system 200 but connected to computer system 200 (e.g., over network 240) may initiate generating state file 238, e.g., by sending a request to NIC processor 234 to generate state file 238, e.g., over network 240). Once state file 238 is ready, NIC processor 234 may send state file 238 to host computer 210. State file 238 may later be used to generate a simulated computer system, as disclosed herein. For example, state file 238 may be sent to a simulator (e.g., simulator 314 presented in FIG. 3) over network 240 or otherwise provided to the simulator.

Processor 234 may generate state file 238 by copying content of memories 250 and/or 232 that are accessible to processor 234 and/or content of hardware registers 236 into state file 238. In some embodiments, processor 234 may organize the copied content in address and data tuples. Other data structures maya be used.

For example, to generate state file 236, processor 234 may translate a range of VAs to get the physical address of a data items, and copy the data items from the physical location in memories 250 and/or 232 to state file 238. In addition, processor 234 may copy the content of registers 236 into state file 238. In some embodiments, the address in the address and data tuples in state file 238 may include the virtual address. In some embodiments, the address in the address and data tuples in state file 238 may include the physical address. In some embodiments, when generating state file 236, processor 234 may first check if a content of certain virtual address is currently cached in DCMC 256. If the content of the virtual address is currently cached in DCMC 256 (e.g., in case of a cache hit), processor 234 may copy the content of the virtual address from DCMC 256 into state file 238. Only if the content of the virtual address is not cached in DCMC 256 (e.g., in case of a cache miss), the system may access the physical address associated with the virtual address in memories 250 and/or 232. In some embodiments, state file 236 may be compressed using any applicable lossless compression scheme. It is noted that in some computer systems 200 other cache levels may exist, e.g., L1 and/or L2 cache levels, etc. In such cases, processor 234 may first check at the lowest level cache first to get the most updated data, and move to the next level cache in case of a cache miss. In some embodiments, a sign or an indication may be added to at least some of the address and data tuples in state file 238 to indicate from which cache level they were copied. Registers 236 and all other memory structures in memory 232 such as memory arrays may be copied to state file 238 as well.

Reference is now made to FIG. 3, which is a block diagram of a simulator 314 of a computer system capable of using state file 238, according to some embodiments. Elements and modules of FIG. 3 may be or may be executed by a computer system such as shown in the example of FIG. 1.

Simulator 314 may be or may include software code or a software application executable by simulator server 310 (e.g., such as processor 105 described above with respect to FIG. 1) and designed to model or mimic the behavior of NIC 230 (or of other simulated computer systems). For example, simulator 314 may include the simulated components as presented in Table 1. Each simulated component may include software code designed to model or mimic the behavior of the corresponding component of NIC 230 or host 210. According to some embodiments, simulator 314 may include simulated components representing or mimicking NIC 230, as well as some sections of host memory 250, e.g., the sections of host memory that are exposed to or accessible by NIC 230 such as user memory 252 and DCM 254, including contexts 255. Modeling or mimicking the behavior of NIC 230 may include presenting to a developer the same results or behavior that would occur if NIC 230 was performing the same actions as the simulated computer system.

TABLE 1
Example components of NIC 230 or host memory 250 and
corresponding simulated components in simulator 314.

| Component of computer system 200 | Simulated component |
|---|---|
| NIC 230 | Simulated NIC 330 |
| NIC processor 234 | Simulated NIC processor 334 |
| Registers 236 | Simulated registers 336 |
| NIC memory 232 | Simulated NIC memory 332 |
| DCMC 256 | Simulated DCMC 356 |
| User memory 252 | Simulated user memory 352 |
| DCM 254 | Simulated DCM 354 |
| Contexts 255 | Simulated contexts 355 |

Simulator server 310 may be connected to a host computer or hypervisor 310. Host computer 310 may be a different physical device than host computer 210, but may be similar in properties to host computer 210. For example, host computer 310, may include processor 314 (e.g., such as processor 105 described above with respect to FIG. 1) that may be similar to host processor 214 and host memory 350 (e.g., such as memory 125 described above with respect to FIG. 1) that may be similar to host memory 250. Host computer or hypervisor 310 may execute a plurality of processes such as virtual machines (VMs) 320A, 320B, 320C . . . 320N (referred herein as “virtual machines 320A-320N”), that may be similar to virtual machines 220A-220N.

Portions or address spaces of host memory 350 may be allocated to various tasks. For example, address spaces in host memory 350 may be allocated to each of user memories 322A-322N. Other allocations may be performed. Parts or all of memory 350 and user memories 322A-322N may be accessible to simulated NIC 330 or to simulated processor 334 of simulated NIC 330. Portions or address spaces of host memory 250 that are allocated to user memory 252 and DCM 254 and contexts 255 may be simulated by simulator 314, e.g., as simulated user memory 352, simulated DCM 354 and simulated contexts 355, respectively, separately from host computer 310.

Simulator server 310 may obtain or receive state file 238 from computer system 200. As described herein, state file 238 may include a recording or listing of content of memories 250 and/or 232 that are accessible to processor 234, and hardware registers 236 of computer system 200, e.g., in address and data tuples. If state file 238 is compressed, simulator server 310 may uncompress state file 238. Simulator server 310 may load or upload content of state file, e.g., data items provided in the address and data tuples in state file 238, to the corresponding simulated address in simulated memories 350 and/or 332 and to simulated registers 336. For example, if the addresses in the address and data tuples are virtual addresses, processor 314 may translate the virtual addresses to physical addresses in memory 350, in simulated memory 332, etc. and may store the data at the correct physical address. Data from registers 236 may be loaded to simulated registers 336.

In some embodiments, addresses in the address and data tuples may be the physical address and the data may be uploaded to the same physical address in simulator 314. In some embodiments, data from the address and data tuples may all be stored in simulated DCMC 356 as if they were all copied from DCMC 256 (even if they were copied from DCM 354 or other memory locations). In some embodiments some of the data may be uploaded to simulated DCMC 356 and some to simulated DCM 354, based on the sign or indication associated with the address and data tuple.

After updating the content of simulated memories 350 and/or 332 and simulated registers 336 based on state file 238, the state of simulator 314 may mimic or be identical to the state of computer device 200 when generating state file 238. At this point, analysis or debug tools 312 that may otherwise be used to extract information from physical computer system 200, may be implemented to extract the same information from simulator 314, e.g., from simulated NIC 330. Those debug tools may be used by developers to observe the state of the simulated computer system and dissect it. For example, some debug tools 312 may read content from simulated memories 350 and/or 332, simulated DCMC 356, and simulated registers 336, parse, analyze or interpret the content and present the parsed, analyzed or interpreted content to the developer. For example, the data stored in log file 238 may be in a binary format, e.g., include logical zeros and ones, or in other format that is used by computers, and the data after parsing may include text and structures that a human can read and understand. debug tools 312 may present or display content from simulated memories 350 and/or 332, simulated DCMC, and simulated registers 336, e.g., organized in relevant structures such as QPs, SQs, RQs, CQs EQs, etc. Debug tools 312 may perform other operations on the content of simulated memories 350 and/or 332 and simulated registers 336, as required by the application. In some embodiments, machine learning (ML) models and/or search tools may be used to analyze state file 238.

Thus, simulator 314 may enable developers to run host software and FW code without needing access to the actual physical device, e.g., to computer system 200. Simulator 314 may load relevant data from state file 238 into elements of simulator 314 that mimic actual memory in computer system 200, giving access to the simulated memory using the same debug tools 312 or analysis tools that could be used on computer system 200, or other debug tools 312 or analysis tools.

In some embodiments, a plurality of state files 238 may be generated by computer system 200 at different points in time, enabling analysis of computer system 200 over time. Each of the generated state files 238 may be uploaded to simulator 314, and the content of simulated memories 350 and/or 332 and simulated registers 336 may be analyzed over time, e.g., using analysis or debug tools 312.

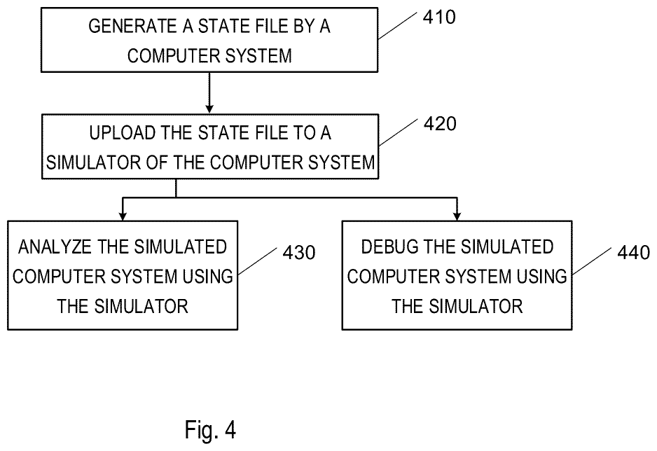

Reference is now made to FIG. 4, which is a flowchart of a method of modeling a computer system, according to some embodiments. The method may be performed using a computing device, such as the computing devices described with respect to FIGS. 1, 2 and 3, but other systems may be used.

In operation 410, a processor may generate a state file of a computer system. For example, the computer system may be computer system 200 or parts of computer system 200 such as NIC 230. The processor generating the state file may be processor 234 of NIC 230, host processor 214, or another processor external to the host (not shown) and the sate file may be state file 238 described above with respect to FIG. 2. Other computer systems may be used. The state file may include data describing content of memory and hardware registers of the computer system and memory or accessible by the computer system at a certain point in time. In some embodiments the content may be organized in address and data tuples. The processor may generate the state file by traversing the virtual address space of processor 234, translating each virtual address used by processor 234 to a physical address, fetching the content of the physical address and storing the address and data in a address and data tuple, e.g., the virtual address being the address in the address and data tuples, and the content being the data in the address and data tuples. If a certain virtual address is mapped to a cache memory of the processor (such as DCMC 256), then the content may be copied from the cache memory.

In some embodiments the computer system may include a processor connected to a host computer executing a plurality of VMs, the hardware registers may include registers of the processor, and the memory may include at least one of: device memory of the processor, cache memory of the processor, host memory, user memory which is accessible to the processor, and user memory allocated to the plurality of VMs which is accessible to the processor. Other computer systems may be used or modeled.

In some embodiments the processor may be a processor of a NIC or network adapter, the hardware registers may include configuration registers on the NIC and the memory may include one or more of device context memory of the NIC, cache memory of the NIC, host memory, user memory which is accessible to the NIC, and user memory allocated to the plurality of VMs which is accessible to the NIC.

In operation 420, the state file may be uploaded to a simulator of the computer system. The simulator may include a software code or application designed to mimic, model or simulate the behavior of the computer system. In some embodiments, uploading the state file to the simulator may include uploading, by the simulator, the data in each of the address and data tuples into the respective address in the simulated memory and hardware registers.

In operation 430, the simulated computer system may be analyzed or simulated, or modeled using the simulator. Analyzing, simulating or modeling the computer system using the simulator may include executing analysis tools on the simulated memory and hardware registers. In operation 440, the simulated computer system may be debugged. In some embodiments, debugging may include executing debug tools, e.g., such as debug tools 312, by the simulator. The executed debug tools may be similar or identical to debug tools that would have been used to debug the physical computer system directly. Thus, in operation 440, bugs in the physical computer system may be analyzed and detected by executing debug tools on the simulator, with no access to the physical computer system. Other debug tools may be used, e.g., debug tools that cannot be used on the computer system for various reasons such as confidentiality and data security issues. Once bugs are detected and solved, software updates may be sent to the physical computer system (e.g., through network such as the Internet or by any other applicable means) and bugs in the physical computer system may be corrected. In some embodiments, executing the debug tools on the simulator may include parsing the data in the simulated memory and hardware registers and displaying the data in the simulated memory and hardware registers, e.g., to a developer. In some embodiments, ML models or search tools may be used to analyze the state file. operation 440 may be performed instead or in addition to operation 430.

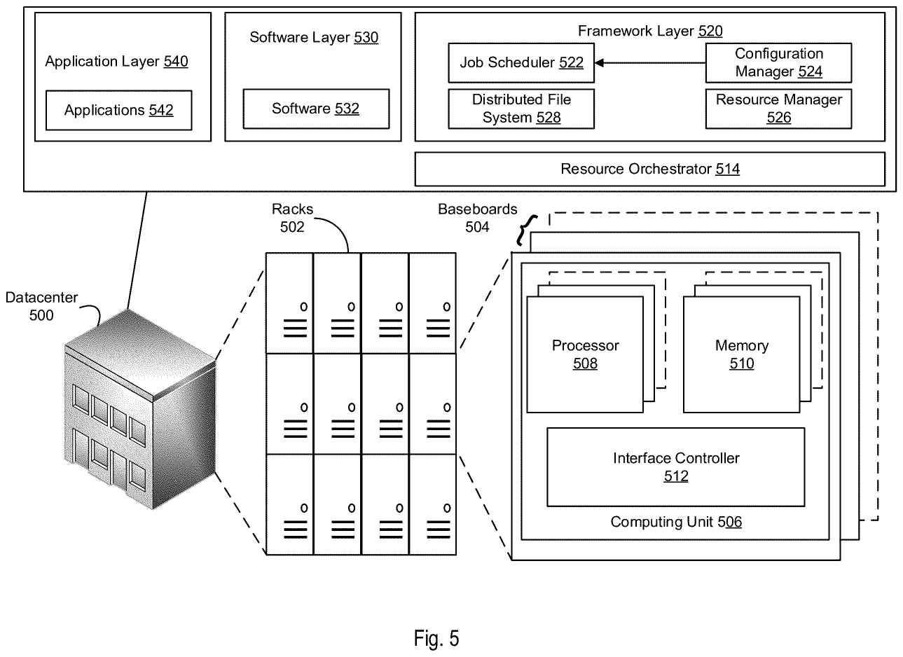

FIG. 5 illustrates an example data center 500, in which at least one embodiment may be used. Data center 500 may include one or more rooms having racks 502 and auxiliary equipment used to house one or more racks 502 and one or more baseboards 504. Rack 502 can include one or more baseboards 504. Rack 502 can include a housing that receives and supports individual baseboards 504. Operational aspects of rack 502 may be regulated at a rack level, corresponding to a group of baseboards 504, or at a baseboard level, corresponding to individual baseboards 504, among other options. Rack 502 or baseboards 504 can have particularly selected maximum operating parameters, such as, but not limited to, power consumption, operating frequencies, and others. Data center 500 can be supported by various cooling systems, such as, but not limited to, cooling towers, cooling loops, pumps, and other support systems. Cooling systems may include sensors and controllers to monitor and managing cooling properties for racks 502. Baseboards 504 within racks 502 can get operational power from one or more power distribution units (PDUs; not shown). PDUs may be arranged within racks 502, for example between racks 502 including baseboards 504, or within racks 502 that also house baseboards 504.

Racks 502 and baseboards 504 can include sub-systems, modules, add-in cards, and other semiconductor components. Baseboards 504 can include one or more computing units 506 that can include one or more processors 508, one or more memory 510, and an interface controller 512. Each of baseboards 504 may be analyzed, modeled, simulated or debugged according to some embodiments. For example, interface controller 512 may generate a state file that may include the content of memory 510, as disclosed herein.

Computing units 506 may include any number of processors, such as, but not limited to, central processing units (“CPUs”), graphics processing units (“GPUs”), or other processors (including accelerators, field programmable gate arrays (FPGAs), graphics processors, etc.), including any processors described herein, such as, but not limited to, processor 105 in FIG. 1. Computing units 506 can include one or more memory storage devices 510 (e.g., dynamic read-only memory, solid state storage or disk drives), as well as network input/output (“NW I/O”) devices, network switches, virtual machines (“VMs”), power modules, and cooling modules, etc. One or more computing units 506 may be a server having one or more of above-mentioned computing resources.

Computing units 506 can include separate groupings of computing units housed within one or more racks (not shown), or many racks housed in data centers at various geographical locations (also not shown). Separate groupings of computing units may include grouped compute, network, memory or storage resources that may be configured or allocated to support one or more workloads. Several computing units (e.g., including CPUs and/or other processors) may be grouped within one or more racks to provide compute resources to support one or more workloads. A resource orchestrator 514 may configure or otherwise control one or more computing units 506 or groups of computing units. Resource orchestrator 514 may include a software design infrastructure (“SDI”) management entity for data center 500. Resource orchestrator 514 may include hardware, software or some combination thereof.

Data center 500 can include any one of or any combination of a framework layer 520, a software layer 530 and an application layer 5340. As shown in FIG. 5, framework layer 520 includes a job scheduler 522, a configuration manager 524, a resource manager 526 and a distributed file system 528. Framework layer 520 may include a framework to support software 532 of software layer 530 and/or one or more application(s) 542 of application layer 540. Software 532 or application(s) 542 may respectively include web-based service software or applications, such as, but not limited to, those provided by Amazon Web Services, Google Cloud and Microsoft Azure. Framework layer 520 may be a type of free and open-source software web application framework such as, but not limited to, Apache Spark™ (hereinafter “Spark”) that may utilize distributed file system 528 for large-scale data processing (e.g., “big data”). Job scheduler 522 may include a Spark driver to facilitate scheduling of workloads supported by various layers of data center 500. Configuration manager 524 may be capable of configuring different layers such as, but not limited to, software layer 530 and framework layer 520 including Spark and distributed file system 528 for supporting large-scale data processing. Resource manager 526 may be capable of managing clustered or grouped computing units 506 mapped to or allocated for support of distributed file system 528 and job scheduler 522. Resource manager 526 may coordinate with resource orchestrator 514 to manage these mapped or allocated computing resources.

Software 532 can be included in software layer 530 and may include software used by at least portions of a computing unit 506, one or more computing units 506, groups of computing units 506, and/or distributed file system 528 of framework layer 520. One or more types of software may include, but are not limited to, Internet web page search software, e-mail virus scan software, database software, and streaming video content software.

Application(s) 542 can be included in application layer 540 and may include one or more types of applications used by at least portions of a computing unit 506, one or more computing units 506, groups of computing units 506, and/or distributed file system 528 of framework layer 520. One or more types of applications may include, but are not limited to, any number of a genomics application, a cognitive compute, application and a machine learning application, including training or inferencing software, machine learning framework software (e.g., PyTorch, TensorFlow, Caffe, etc.) or other machine learning applications used in conjunction with one or more embodiments.

Any of configuration manager 524, resource manager 526, and resource orchestrator 514 may implement any number and type of self-modifying actions based on any amount and type of data acquired in any technically feasible fashion. Self-modifying actions may relieve a data center operator of data center 500 from making possibly bad configuration decisions and possibly avoiding underutilized and/or poor performing portions of a data center.

Data center 500 may include tools, services, software or other resources to train one or more machine learning models or predict or infer information using one or more machine learning models in accordance with one or more embodiments described herein. For example, a machine learning model may be trained by calculating weight parameters in accordance with a neural network architecture using software and computing resources described above with respect to data center 500. Trained machine learning models corresponding to one or more neural networks may be used to infer or predict information using resources described above with respect to data center 500 by using weight parameters calculated through one or more training techniques described herein.

Data center 500 may use CPUs, application-specific integrated circuits (ASICs), GPUs, FPGAs, or other hardware to perform some or all of processes and techniques described elsewhere herein, such as, but not limited to, training and/or inferencing using above-described resources. Moreover, one or more software and/or hardware resources described herein may be configured as a service to allow users to train or perform inferencing of information, such as, but not limited to, image recognition, speech recognition, or other artificial intelligence services.

One skilled in the art will realize the embodiments may be embodied in other specific forms without departing from the spirit or essential characteristics thereof. The foregoing embodiments are therefore to be considered in all respects illustrative rather than limiting of the embodiments described herein. Scope of the embodiments is thus indicated by the appended claims, rather than by the foregoing description, and all changes that come within the meaning and range of equivalency of the claims are therefore intended to be embraced therein.

In the foregoing detailed description, numerous specific details are set forth in order to provide an understanding of the embodiments. However, it will be understood by those skilled in the art that the embodiments can be practiced without these specific details. In other instances, well-known methods, procedures, and components, modules, units and/or circuits have not been described in detail so as not to obscure the embodiments. Some features or elements described with respect to one embodiment can be combined with features or elements described with respect to other embodiments.

Although embodiments of the embodiments are not limited in this regard, discussions utilizing terms such as, for example, “processing,” “computing,” “calculating,” “determining,” “establishing”, “analyzing”, “checking”, or the like, can refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that can store instructions to perform operations and/or processes.

Although embodiments of the embodiments are not limited in this regard, the terms “plurality” and “a plurality” as used herein can include, for example, “multiple” or “two or more”. The terms “plurality” or “a plurality” can be used throughout the specification to describe two or more components, devices, elements, units, parameters, or the like. The term set when used herein can include one or more items. Unless explicitly stated, the method embodiments described herein are not constrained to a particular order or sequence. Additionally, some of the described method embodiments or elements thereof can occur or be performed simultaneously, at the same point in time, or concurrently.

1. A method for modeling a computer system, the method comprising:
uploading to a simulator of the computer system a state file of the computer system, the state file comprising data describing content of memory and hardware registers of the computer system, to generate a simulated computer system; and
analyzing the simulated computer system using the simulator.

2. The method of claim 1, wherein the computer system comprises a processor connected to a host computer executing a plurality of virtual machines (VMs), wherein the hardware registers comprise configuration registers of the processor, and wherein the memory comprises at least one of: device memory of the processor, cache memory of the processor, host memory, user memory which is accessible to the processor, and user memory allocated to the plurality of VMs which is accessible to the processor.

3. The method of claim 1, wherein the computer system comprises a network interface card (NIC) connected to a host computer and executing a plurality of virtual machines (VMs).

4. The method of claim 3, wherein the hardware registers comprise configuration registers on the NIC and wherein the memory comprises at least one of: device context memory of the NIC, cache memory of the NIC, host memory, user memory which is accessible to the NIC, and user memory allocated to the plurality of VMs which is accessible to the NIC.

5. The method of claim 1, wherein the simulator comprises a software application designed to mimic the behavior of the computer system.

6. The method of claim 1, wherein generating the state file comprises copying content of the memory and hardware registers to the state file in address and data tuples.

7. The method of claim 6, wherein the simulator comprises a software application designed to mimic behavior of the computer system, wherein the simulated computer system comprises simulated memory and hardware registers, and wherein uploading the state file to the simulator comprises uploading, by the simulator, the data in each of the address and data tuples into the respective address in the simulated memory and hardware registers.

8. The method of claim 1, wherein analyzing the computer system using the simulator comprises executing analysis tools on the simulated memory and hardware registers.

9. The method of claim 8, wherein executing the debug tools on the simulator comprises displaying data in the simulated memory and hardware registers.

10. The method of claim 1, comprising using at least one of machine learning (ML) models or search tools to analyze the state file.

11. A device comprising:
a memory; and
one or more processors to:
execute a simulator of a computer system;
upload to the simulator of a state file of the computer system, the state file comprising data describing content of memory and hardware registers of the computer system, to generate a simulated computer system; and
analyze the simulated computer system using the simulator.

12. The device of claim 11, wherein the computer system comprises a processor connected to a host computer executing a plurality of virtual machines (VMs), wherein the hardware registers comprise configuration registers of the processor, and wherein the memory comprises at least one of: device memory of the processor, cache memory of the processor, host memory, user memory which is accessible to the processor, and user memory allocated to the plurality of VMs which is accessible to the processor.

13. The device of claim 11, wherein the computer system comprises a network interface card (NIC) connected to a host computer and executing a plurality of virtual machines (VMs).

14. The device of claim 13, wherein the hardware registers comprise configuration registers on the NIC and wherein the memory comprises at least one of: device context memory of the NIC, cache memory of the NIC, host memory, user memory which is accessible to the NIC, and user memory allocated to the plurality of VMs which is accessible to the NIC.

15. The device of claim 11, wherein the simulator comprises a software application designed to mimic the behavior of the computer system.

16. The device of claim 11, wherein generating the state file comprises copying content of the memory and hardware registers to the state file in address and data tuples.

17. The device of claim 16, wherein the simulator comprises a software application designed to mimic behavior of the computer system, wherein the simulated computer system comprises simulated memory and hardware registers, and wherein the processor to upload the state file to the simulator by uploading the data in each of the address and data tuples into the respective address in the simulated memory and hardware registers.

18. The device of claim 11, wherein the processor to analyze the computer system using the simulator by executing analysis tools on the simulated memory and hardware registers.

19. The device of claim 18, wherein the processor to execute the debug tools on the simulator by displaying data in the simulated memory and hardware registers.

20. The device of claim 11, wherein the processor to use at least one of machine learning (ML) models or search tools to analyze the state file.
